(19) United States
(12) Patent Application Publication
(10) Pub. No.: US 2017/0183496 A1
(43) Pub. Date: Jun. 29, 2017

(54) Thermoplastic Resin Composition and Molded Article Using the Same

(71) Applicant: Lotte Advanced Materials Co., Ltd., Yeosu-si (KR)

(72) Inventors: Kee Hae KWON, Uiwang-si (KR); Won KO, Uiwang-si (KR); In Chol KIM, Uiwang-si (KR); Chang Min HONG, Uiwang-si (KR)

(21) Appl. No.: 15/374,057

(22) Filed: Dec. 9, 2016

(30) Foreign Application Priority Data
Dec. 24, 2015 (KR) 10-2015-0186481

(51) Int. Cl. C08L 69/00

(52) U.S. Cl. CPC C08L 69/00; C08L 2201/08; C08L 2205/025; C08L 2205/03; C08L 2205/035

(57) ABSTRACT

Disclosed herein are a thermoplastic resin composition and a molded article formed of the same. The thermoplastic resin composition includes: a base resin comprising a polycarbonate resin, and first and second vinyl-modified graft copolymers comprising rubbery polymers having different average indexes of refraction respectively; and metal particles, wherein a difference between the average indexes of refractions of the rubbery polymers is greater than or equal to about 0.02.

### CROSS-REFERENCE TO RELATED APPLICATION

This application claims priority under 35 USC Section 119 to and the benefit of Korean Patent Application 10-2015-0186481, filed on Dec. 24, 2015, in the Korean Intellectual Property Office, the entire disclosure of which is incorporated herein by reference.

### FIELD

The present invention relates to a thermoplastic resin composition and a molded article formed of the same.

### BACKGROUND

A thermoplastic resin has a lower specific gravity than glass or metal and has excellent moldability and mechanical properties such as impact resistance. Plastic products made using a thermoplastic resin such as a polycarbonate resin are rapidly replacing glass and metal products in the fields of electric/electronic products and automotive parts.

Recently, as the demand for environmentally friendly unpainted resins increases, there is increasing demand for a metallic material capable of realizing an appearance having a metal texture without a painting process. In particular, as plastic materials for automotive interiors and exteriors, matte or low-gloss resins are widely used to create a luxurious feel.

For this purpose, metallic resins using metal particles are continuously being developed. However, these resins require additional mold modification after injection molding or are limited in their applications due to deterioration in appearance caused by the metal particles.

There have been attempts to address these problems by adjusting the shape and aspect ratio of metal particles and improving surface coating materials. However, improvement of metal particles has a limitation in solving deterioration in appearance due to agglomeration, uneven orientation and unequal distribution of the metal particles occurring during injection molding of a metallic resin.

In addition, large-diameter rubber polymer particles or a matting agent can be used to lower gloss of a metallic resin to make agglomerated or unequally distributed metal particles invisible. However, a large amount of the large-diameter rubber polymer particles must be used in order to obtain a satisfactory matting effect, and UV stability and physical properties can deteriorate due to an excess of the polymer particles. In addition, when a matting agent is used, physical properties such as impact resistance and fluidity can deteriorate.

Therefore, there is a need for a thermoplastic resin composition which can have low gloss to provide improved concealment of metal particles with minimal or no deterioration in physical properties such as impact resistance.

In addition, recently, in the case of automobile interior materials, as design trends are diversified, both painted resins and unpainted resins can be used for automotive parts. Therefore, there is also a need for a material which can have excellent chemical resistance and is thus free from problems such as cracking and erosion during painting.

### SUMMARY OF THE INVENTION

Exemplary embodiments relate to a thermoplastic resin composition that can have a high-quality appearance with a metal texture without requiring a separate painting or plating process, and to a molded article formed of the same.

In exemplary embodiments, the thermoplastic resin composition can realize an appearance having a metal texture without painting, can provide good concealing properties to prevent deterioration in appearance due to agglomeration, unequal distribution, and/or uneven orientation of metal particles, and can have excellent chemical resistance.

In exemplary embodiments, the thermoplastic resin composition can also have excellent properties in terms of impact resistance and UV stability.

Exemplary embodiments also relate to a molded article which is formed of the thermoplastic resin composition as set forth above and can have excellent properties in terms of appearance quality, impact resistance, chemical resistance, and UV stability.

A thermoplastic resin composition can include: a base resin including a polycarbonate resin, a first vinyl-modified graft copolymer, and a second vinyl-modified graft copolymer, the first and second vinyl-modified graft copolymers including rubbery polymers having different average indexes of refraction, respectively; and metal particles, wherein a difference between the average indexes of refraction of the rubbery polymers is greater than or equal to about 0.02.

The rubbery polymer of the first vinyl-modified graft copolymer may have an average index of refraction of greater than about 1.49 to about 1.53, and the rubbery polymer of the second vinyl-modified graft copolymer may have an average index of refraction of about 1.39 to about 1.49.

The first vinyl-modified graft copolymer may include a diene-based rubbery polymer and the second vinyl-modified graft copolymer may include an acrylic rubbery polymer.

The base resin may include about 40 wt % to about 90 wt % of the polycarbonate resin, about 5 wt % to about 50 wt % of the first vinyl-modified graft copolymer, and about 1 wt % to about 50 wt % of the second vinyl-modified graft copolymer.

The metal particles may have an average particle diameter (D50) of about 5 μm to about 100 μm and may be present in an amount of about 0.1 parts by weight to about 10 parts by weight based on about 100 parts by weight of the base resin.

The base resin may further include an aromatic vinyl copolymer, wherein the aromatic vinyl copolymer may be present in an amount of about 30 wt % or less in the base resin.

The thermoplastic resin composition may further include a UV stabilizer, wherein the UV stabilizer may be present in an amount of greater than about 0 to about 4 parts by weight or less based on about 100 parts by weight of the base resin.

In exemplary embodiments, there is provided a molded article formed of the thermoplastic resin composition according to the present invention.

The molded article may have a gloss of about 85 GU or less, as measured at an angle of 60 degrees in accordance with ASTM D523 and a color difference (ΔE) of about 2.0 or less, as measured before and after UV exposure at 2,400 kJ/m² in accordance with FLTM B0116-1.

The thermoplastic resin composition according to the present invention includes at least two vinyl-modified graft copolymers having different indexes of refraction, which can provide low gloss and improved concealing properties, thereby preventing deterioration in appearance due to agglomeration, unequal distribution, and/or uneven orientation of metal particles while realizing a metal texture without painting.

In addition, the thermoplastic resin composition according to the present invention can have excellent properties in terms of impact resistance and chemical resistance and thus can be used for components using both painted materials and unpainted materials.

Further, the thermoplastic resin composition according to the present invention can include a UV stabilizer and thus can exhibit excellent UV stability.

### DETAILED DESCRIPTION

The above and other aspects, features, and advantages of the present invention will become apparent from the detailed description of the following embodiments. It should be understood that the present invention is not limited to the following embodiments and may be embodied in different ways, and that the embodiments are provided for complete disclosure and thorough understanding of the present invention by those skilled in the art. The scope of the present invention should be defined only by the appended claims.

As a result of repeated studies for developing a thermoplastic resin composition capable of preventing deterioration in appearance quality caused by unequal distribution of metal particles, having excellent impact resistance and chemical resistance, and eliminating a need for painting, the present inventors found that the above can be achieved using at least two vinyl-modified graft copolymers including rubbery polymers having different indexes of refraction, respectively, and completed the present invention.

A thermoplastic resin composition according to the present invention includes: a base resin including a polycarbonate resin, and a first vinyl-modified graft copolymer and a second vinyl-modified graft copolymer including rubbery polymers having different indexes of refraction, respectively; and metal particles, wherein a difference in average index of refraction between the rubbery polymers is greater than or equal to about 0.02.

Next, details of each component of the thermoplastic resin composition according to the present invention will be described.

<Base Resin>

(A) Polycarbonate Resin

The polycarbonate resin is an aromatic polycarbonate resin prepared by reacting phosgene, halogen formate, or carbonic diester with one or more diphenols represented by Formula 1:

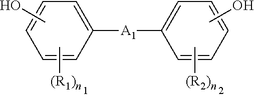

wherein A₁ is a single bond, a substituted or unsubstituted C₁ to C₅ alkylene group, a substituted or unsubstituted C₁ to C₅ alkylidene group, a substituted or unsubstituted C₃ to C₆ cycloalkylene group, a substituted or unsubstituted C₅ to C₆ cycloalkylidene group, CO, S, or SO₂; R₁ and R₂ are the same or different and are each independently a substituted or unsubstituted C₁ to C₃₀ alkyl group or a substituted or unsubstituted C₆ to C₃₀ aryl group; and n₁ and n₂ are the same or different and are each independently an integer from 0 to 4.

As used herein, unless otherwise defined, the term “substituted” means that a hydrogen atom in a functional group is substituted with at least one substituent, for example, one or more of a halogen group, a C₁ to C₃₀ alkyl group, a C₁ to C₃₀ haloalkyl group, a C₆ to C₃₀ aryl group, a C₂ to C₃₀ heteroaryl group, a C₁ to C₂₀ alkoxy group, or a combination thereof.

As used herein, unless otherwise defined, the term “hetero” refers to at least one hetero atom of N, O, S and/or P, instead of at least one carbon atom of a cyclic substituent.

Examples of the diphenols may include without limitation hydroquinone, resorcinol, 4,4′-dihydroxyphenyl, 2,2-bis-(4-hydroxyphenyl)-propane, 2,4-bis-(4-hydroxyphenyl)-2-methylbutane, 1,1-bis-(4-hydroxyphenyl)-cyclohexane, 2,2-bis-(3,5-dichloro-4-hydroxyphenyl)-propane, 2,2-bis-(3-methyl-4-hydroxyphenyl)-propane, 2,2-bis-(3,5-dimethyl-4-hydroxyphenyl)-propane, and the like, and mixtures thereof. For example, the diphenol(s) may include 2,2-bis-(4-hydroxyphenyl)-propane, 2,2-bis-(3,5-dichloro-4-hydroxyphenyl)-propane, 2,2-bis-(3-methyl-4-hydroxyphenyl)-propane, 2,2-bis-(3,5-dimethyl-4-hydroxyphenyl)-propane, and/or 1,1-bis-(4-hydroxyphenyl)-cyclohexane. In exemplary embodiments, the diphenol(s) may include 2,2-bis-(4-hydroxyphenyl)-propane, which is also referred to as bisphenol A.

The polycarbonate resin may have a weight average molecular weight (Mw) of about 10,000 g/mol to about 50,000 g/mol, for example about 15,000 g/mol to about 40,000 g/mol, and as another example about 25,000 g/mol to about 40,000 g/mol, without being limited thereto.

The polycarbonate resin may be a branched polycarbonate resin. For example, the polycarbonate resin may be a polycarbonate resin prepared by adding a tri- or higher polyfunctional compound, for example, a tri- or higher valent phenol group-containing compound, in an amount of about 0.05 mol % to about 2 mol % based on the total number of moles of the diphenols which are used in polymerization.

The polycarbonate resin may be a homopolycarbonate resin, a copolycarbonate resin, or a blend thereof.

In addition, the polycarbonate resin may be partly or completely replaced by an aromatic polyester-carbonate resin obtained by polymerization in the presence of an ester precursor, for example, bifunctional carboxylic acid.

The base resin can include the polycarbonate resin in an amount of about 40 wt % to about 90 wt %, for example about 40 wt % to about 85 wt %, and as another example about 50 wt % to about 80 wt %, for example, 50 wt %, 55 wt %, 60 wt %, 65 wt %, 70 wt %, 75 wt %, or 80 wt %, based on the total weight (100 wt %) of the base resin. In some embodiments, the base resin can include the polycarbonate resin in an amount of about 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90 wt %. Further, according to some embodiments, the amount of the polycarbonate resin can be in a range from about any of the foregoing amounts to about any other of the foregoing amounts.

Within this range, the thermoplastic resin composition can have excellent mechanical properties.

(B) Vinyl-Modified Graft Copolymer

The thermoplastic resin composition includes two vinyl-modified graft copolymers including rubbery polymers having different average indexes of refraction, respectively. In exemplary embodiments, the thermoplastic resin composition includes a first vinyl-modified graft copolymer and a second vinyl-modified graft copolymer, wherein a difference between the average indexes of refraction of rubbery polymers included in the first vinyl-modified graft copolymer and the second vinyl-modified graft copolymer respectively is greater than or equal to about 0.02. In exemplary embodiments, the upper limit of the difference between the average indexes of refraction of the rubbery polymers may be about 0.14, without being limited thereto.

When a difference between the average indexes of refraction of the rubbery polymers included in the first vinyl-modified graft copolymer and the second vinyl-modified graft copolymer respectively is greater than or equal to about 0.02, the gloss of the thermoplastic resin composition can be lowered due to the difference in index of refraction between the vinyl-modified graft copolymers to improve concealing properties, such that it is possible to prevent deterioration in appearance due to uneven orientation, unequal distribution, and/or agglomeration of the metal particles.

For example, a difference between the average indexes of refraction of the rubbery polymers included in the first vinyl-modified graft copolymer and the second vinyl-modified graft copolymer respectively may be about 0.02, 0.03, 0.04, 0.05, 0.06, 0.07, 0.08, 0.09, 0.10, 0.11, 0.12, 0.13, or 0.14. Within this range, the thermoplastic resin composition can provide further improved concealing properties, and the metal particles can have further improved properties in terms of orientation, dispersibility, and uniformity.

Each of the vinyl-modified graft copolymers may be a resin polymer in which a grafted rubbery polymer is dispersed in the form of particles in a matrix (continuous phase) composed of a copolymer of vinyl-based monomers. Each of the vinyl-modified graft copolymers may be prepared by adding vinyl-based monomers copolymerizable with a rubbery polymer in the presence of the rubbery polymer, followed by polymerization. Here, polymerization may be performed by any typical known polymerization method such as emulsion polymerization, solution polymerization, suspension polymerization, and mass polymerization.

(B-1) First Vinyl-Modified Graft Copolymer

The first vinyl-modified graft copolymer (B-1) may be a graft copolymer including a rubbery polymer.

The first vinyl-modified graft copolymer includes a rubbery polymer having a higher index of refraction than the rubbery polymer of the second vinyl-modified graft copolymer to be described below. In exemplary embodiments, the rubbery polymer of the first vinyl-modified graft copolymer may have an average index of refraction of greater than about 1.49, for example higher than about 1.49 to about 1.53, for example, 1.49, 1.50, 1.51, 1.52, or 1.53. Within this range, the thermoplastic resin composition can have low gloss and further improved concealing properties while exhibiting excellent properties in terms of impact resistance, chemical resistance, and appearance.

The first vinyl-modified graft copolymer may be prepared by forming a rubbery polymer core, followed by graft polymerization of a monomer polymerizable with the core to form a shell, or may be a resin polymer in which a grafted rubbery polymer is dispersed in the form of particles in a matrix (a continuous phase) composed of a copolymer of vinyl-based monomers.

The rubbery polymer of the first vinyl-modified graft copolymer may be a diene-based rubbery polymer formed by polymerization of diene rubbers, such as a butadiene-based rubbery polymer. When a diene-based rubbery polymer is used as the rubbery polymer, it is possible to achieve a high index of refraction exceeding about 1.49.

Examples of the diene rubbers may include without limitation diene rubbers such as polybutadiene, styrene-butadiene copolymers, acrylonitrile-butadiene copolymers, poly(organosiloxane-butadiene) rubbers, saturated rubbers obtained by adding hydrogen to the diene rubbers, and the like, and mixtures thereof.

Examples of the monomer graft-polymerizable with the rubbery polymer may include without limitation styrene, C1-C10 alkyl-substituted styrene monomers, (meth)acrylonitrile, (meth)acrylate monomers, C1-C10 alkyl (meth)acrylate monomers, and the like. These may be used alone or as a mixture thereof.

The base resin can include the first vinyl-modified graft copolymer in an amount of about 5 wt % to about 50 wt %, for example about 10 wt % to about 40 wt %, and as another example about 10 wt % to about 30 wt %, for example, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, or 30 wt %, based on the total weight (100 wt %) of the base resin. In some embodiments, the base resin can include the first vinyl-modified graft copolymer in an amount of about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 wt %. Further, according to some embodiments, the amount of the first vinyl-modified graft copolymer can be in a range from about any of the foregoing amounts to about any other of the foregoing amounts.

Within this range, the thermoplastic resin composition can have excellent properties in terms of impact resistance, chemical resistance, and appearance.

(B-2) Second Vinyl-Modified Graft Copolymer

The second vinyl-modified graft copolymer (B-2) may be a graft copolymer including a rubbery polymer.

The second vinyl-modified graft copolymer includes a rubbery polymer having a lower index of refraction than the rubbery polymer of the first vinyl-modified graft copolymer. In exemplary embodiments, the rubbery polymer of the second vinyl-modified graft copolymer may have an average index of refraction of about 1.49 or less, for example about 1.39 to about 1.49. For example, the rubbery polymer of the second vinyl-modified graft copolymer may have an average index of refraction of 1.39, 1.40, 1.41, 1.42, 1.43, 1.44, 1.45, 1.46, 1.47, 1.48, or 1.49. Within this range, the thermoplastic resin composition can have low gloss and further improved concealing properties while exhibiting excellent properties in terms of impact resistance, chemical resistance, and appearance.

The first vinyl-modified graft copolymer may be prepared by forming a rubbery polymer core, followed by graft polymerization of a monomer polymerizable with the core to form a shell, or may be a resin polymer in which a grafted rubbery polymer is dispersed in the form of particles in a matrix (a continuous phase) composed of a copolymer of vinyl-based monomers.

The rubbery polymer of the second vinyl-modified graft copolymer may be an acrylic rubbery polymer formed by polymerization of acrylic rubbery monomers. When the rubbery polymer is formed of acrylic rubbery monomers, it is possible to obtain a graft copolymer having a relatively low index of refraction, that is, an index of refraction of about 1.49 or less.

Examples of the acrylic rubbery monomers may include without limitation one or more of C₄ to C₂₀ alkyl(meth)acrylates, for example, butyl (meth)acrylate, hexyl (meth)acrylate, ethylhexyl (meth)acrylate, stearyl (meth)acrylate, lauryl (meth)acrylate, and the like, and mixtures thereof. For example, butyl (meth)acrylate may be used as the acrylic rubbery monomer.

Examples of the rubbery polymer of the second vinyl-modified graft copolymer may include without limitation a polymer including at least one of butyl (meth)acrylate, hexyl (meth)acrylate, ethylhexyl (meth)acrylate, stearyl (meth)acrylate, and/or lauryl (meth)acrylate, a copolymer of an acrylic rubbery monomer and an organosiloxane, for example, poly(organosiloxane-butyl acrylate), and the like, and mixtures thereof.

Examples of the monomer graft-polymerizable with the rubbery polymer may include without limitation styrene, C1-C10 alkyl-substituted styrene monomers, (meth)acrylonitrile, (meth)acrylate monomers, C1-C10 alkyl (meth)acrylate monomers, and the like, which may be used alone or as a mixture thereof.

The base resin can include the second vinyl-modified graft copolymer in an amount of about 1 wt % to about 50 wt %, for example about 1 wt % to about 30 wt %, and as another example about 1 wt % to about 20 wt %, for example, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, or 20 wt %, based on the total weight (100 wt %) of the base resin. In some embodiments, the base resin can include the second vinyl-modified graft copolymer in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 wt %. Further, according to some embodiments, the amount of the second vinyl-modified graft copolymer can be in a range from about any of the foregoing amounts to about any other of the foregoing amounts.

Within this range, the thermoplastic resin composition can have excellent properties in terms of impact resistance, chemical resistance, and appearance.

(C) Aromatic Vinyl Copolymer

The base resin of the thermoplastic resin composition may further optionally include an aromatic vinyl copolymer, as needed.

The aromatic vinyl copolymer can be formed by copolymerization of a vinyl cyanide compound with an aromatic vinyl compound.

Examples of the vinyl cyanide compound may include without limitation acrylonitrile, methacrylonitrile, fumaronitrile, and the like, and combinations thereof.

Examples of the aromatic vinyl compound may include without limitation styrene, α-methylstyrene, halogen and/or C1-C10 alkyl-substituted styrene, and the like, and combinations thereof.

The vinyl cyanide compound-aromatic vinyl compound copolymer may be formed by copolymerization of a mixture of the aromatic vinyl compound and the vinyl cyanide compound in which the aromatic vinyl compound is present in an amount of about 60 wt % to about 85 wt %, for example about 65 wt % to about 80 wt %, for example, 65 wt %, 66 wt %, 67 wt %, 68 wt %, 69 wt %, 70 wt %, 71 wt %, 72 wt %, 73 wt %, 74 wt %, 75 wt %, 76 wt %, 77 wt %, 78 wt %, 79 wt %, or 80 wt %, based on the total weight (100 wt %) of the vinyl cyanide compound-aromatic vinyl compound copolymer. In some embodiments, the vinyl cyanide compound-aromatic vinyl compound copolymer can include the aromatic vinyl compound in an amount of about 60, 61, 62, 63, 64, 65, 66, 67, 68, 69, 70, 71, 72, 73, 74, 75, 76, 77, 78, 79, 80, 81, 82, 83, 84, or 85 wt %. Further, according to some embodiments, the amount of the aromatic vinyl compound can be in a range from about any of the foregoing amounts to about any other of the foregoing amounts.

The vinyl cyanide compound-aromatic vinyl compound copolymer may have a weight average molecular weight of about 50,000 g/mol to about 400,000 g/mol, for example about 50,000 g/mol to about 200,000 g/mol, and as another example about 50,000 g/mol to about 150,000 g/mol.

The vinyl cyanide compound-aromatic vinyl compound copolymer may be a styrene-acrylonitrile copolymer (SAN) resin.

The styrene-acrylonitrile copolymer resin may be formed by copolymerization of about 60 wt % to about 85 wt % of a styrene monomer with about 15 wt % to about 40 wt % of an acrylonitrile monomer, for example, may be formed by copolymerization of about 65 wt % to about 80 wt % of a styrene monomer with about 20 wt % to about 35 wt % of an acrylonitrile monomer. When the amounts of the monomers of the styrene-acrylonitrile copolymer resin fall within the above ranges, the phase distribution of the vinyl-modified graft copolymer in the polycarbonate resin composition can be stable, thereby improving the impact resistance and appearance of the resin composition.

The base resin can include the aromatic vinyl copolymer, when present, in an amount of 30 wt % or less, for example about 1 wt % to about 30 wt %, and as another example about 5 wt % to about 20 wt %, for example, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, or 20 wt %, based on the total weight (100 wt %) of the base resin. In some embodiments, the base resin can include the aromatic vinyl copolymer in an amount of 0 (the base resin does not include the aromatic vinyl copolymer), about 0 (the base resin does include the aromatic vinyl copolymer), 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 wt %. Further, according to some embodiments, the amount of the aromatic vinyl copolymer can be in a range from about any of the foregoing amounts to about any other of the foregoing amounts.

Within this range, it is possible to improve the impact resistance and appearance quality of the thermoplastic resin composition.

(D) Metal Particles

The metal particles may include one or more metal particles. Examples of the metal particles may include without limitation aluminum particles, although any suitable metal and/or alloy particles may be used as the metal particles.

The thermoplastic resin composition can include the metal particles (D) in an amount of about 0.1. to about 10 parts by weight, for example about 0.1 parts by weight to about 5 parts by weight, and as another example about 0.1 parts by weight to about 2 parts by weight, based on about 100 parts by weight of the base resin. In some embodiments, the thermoplastic resin composition can include the metal particles in an amount of about 0.1, 0.2, 0.3, 0.4, 0.5, 0.6, 0.7, 0.8, 0.9, 1, 2, 3, 4, 5, 6, 7, 8, 9, or 10 parts by weight. Further, according to some embodiments, the amount of the metal particles can be in a range from about any of the foregoing amounts to about any other of the foregoing amounts.

If the amount of the metal particles is less than about 0.1 parts by weight, it can be difficult to realize an appearance having a metal texture, whereas, if the amount of the metal particles exceeds about 10 parts by weight, the resin composition can have poor moldability and mechanical properties.

The metal particles may have an average particle diameter (D50) of about 5 μm to about 100 μm, for example about 10 μm to about 60 μm. If the average particle diameter (D50) of the metal particles is less than about 5 μm or exceeds about 100 μm, it can be difficult to realize an appearance having a metal texture and the metal particles can be unevenly oriented or distributed, making realization of good appearance quality difficult.

For example, the metal particles may have an average particle diameter (D50) of 10 μm, 15 μm, 20 μm, 25 μm, 30 μm, 35 μm, 40 μm, 45 μm, 50 μm, 55 μm, or 60 μm. Within this range, orientation, dispersibility and uniformity of the metal particles in the thermoplastic resin composition can be further improved.

The metal particles may only include metal particles having the same average particle diameter (D50) or may include two or more metal particles having different average particle diameters (D50). Here, the type of the metal particles may vary depending on a desired metal texture.

(E) UV Stabilizer

The thermoplastic resin composition may further optionally include a UV stabilizer, as needed. The UV stabilizer may be any suitable UV stabilizer known in the art without limitation. Examples of the UV stabilizer may include without limitation benzotriazole, benzophenone, triazine, and/or salicylic acid phenyl ester based UV stabilizers.

The thermoplastic resin composition can include the UV stabilizer in an amount of about 4 parts by weight or less, for example about 0.1 parts by weight to about 4 parts by weight, for example, 0.1 parts by weight, 0.5 parts by weight, 1 part by weight, 1.5 parts by weight, 2 parts by weight, 2.5 parts by weight, 3 parts by weight, 3.5 parts by weight, or 4 parts by weight, based on about 100 parts by weight of the base resin. In some embodiments, the thermoplastic resin composition can include the UV stabilizer in an amount of 0 (the UV stabilizer is not present), about 0 (the UV stabilizer is present), 0.1, 0.2, 0.3, 0.4, 0.5, 0.6, 0.7, 0.8, 0.9, 1, 2, 3, or 4 parts by weight. Further, according to some embodiments, the amount of the UV stabilizer can be in a range from about any of the foregoing amounts to about any other of the foregoing amounts.

Within this range, the efficacy of the UV stabilizer in preventing physical and chemical degradation caused by light can be further improved.

(F) Additives

The thermoplastic resin composition may optionally further include one or more additives (F), as needed. Examples of the additives (F) may include without limitation flame retardants, lubricants, plasticizers, heat stabilizers, antioxidants, light stabilizers, release agents, colorants, and the like, and combinations thereof.

The flame retardant serves to reduce flammability. Examples of the flame retardant can include without limitation at least one of a phosphate compound, a phosphite compound, a phosphonate compound, a polysiloxane, a phosphazene compound, a phosphinate compound, a melamine compound, and the like, and mixtures thereof.

The lubricant serves to lubricate a metal surface that contacts the thermoplastic resin composition in order to facilitate flow or movement of the composition during processing, molding or extrusion, and may include any suitable lubricant typically used in the art.

The plasticizer serves to increase flexibility, processability or expandability of the thermoplastic resin composition, and may include any suitable plasticizer typically used in the art.

The heat stabilizer serves to suppress thermal decomposition of the thermoplastic resin composition when the resin composition is kneaded or molded at high temperature, and may include any suitable heat stabilizer generally used in the art.

The antioxidant serves to inhibit or block the chemical reaction between the thermoplastic resin composition and oxygen, thereby preventing the thermoplastic resin composition from being degraded and losing inherent properties thereof. Examples of the antioxidant can include without limitation at least one of phenol, phosphite, thioether and/or amine antioxidants.

The light stabilizer serves to protect the thermoplastic resin composition from ultraviolet rays, thereby preventing the thermoplastic resin composition from being decomposed and losing color or losing mechanical properties thereof, and may include, for example, titanium dioxide.

The colorant may include any typical pigment and/or dye.

The thermoplastic resin composition can include the additives (F) in an amount of about 1 part by weight to about 15 parts by weight, for example about 1 part by weight to about 8 parts by weight, for example 1 part by weight, 1.5 parts by weight, 2 parts by weight, 2.5 parts by weight, 3 parts by weight, 3.5 parts by weight, 4 parts by weight, 4.5 parts by weight, 5 parts by weight, 5.5 parts by weight, 6 parts by weight, 6.5 parts by weight, 7 parts by weight, 7.5 parts by weight, or 8 parts by weight, based on about 100 parts by weight of the base resin. In some embodiments, the thermoplastic resin composition can include the additives in an amount of 0 (the additive is not present), about 0 (the additive is present), 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, or 15 parts by weight. Further, according to some embodiments, the amount of the additive can be in a range from about any of the foregoing amounts to about any other of the foregoing amounts.

Within this range, the additives (F) can provide the above effects with minimal or no deterioration of the appearance and physical properties of the thermoplastic resin composition.

The thermoplastic resin composition according to the present invention may be prepared by any suitable known method. For example, the above components and optional additives may be mixed using a Henschel mixer, a V blender, a tumbler blender, or a ribbon blender, followed by melt extrusion in a single screw extruder or a twin screw extruder, thereby preparing a thermoplastic resin in pellet form.

Exemplary embodiments also include a molded article formed of the thermoplastic resin composition as set forth above. For example, the thermoplastic resin composition may be produced into a molded article by any known method such as injection molding, blow molding, extrusion, and casting.

The molded article according to the present invention can realize a high-quality appearance having a metal texture without painting and can have excellent impact resistance, chemical resistance and UV stability.

The molded article according to the present invention may have a gloss of about 85 GU or less, for example about 20 GU to about 85 GU, and as another example about 20 GU to about 80 GU, for example, 20 GU, 25 GU, 30 GU, 35 GU, 40 GU, 45 GU, 50 GU, 55 GU, 60 GU, 65 GU, 70 GU, 75 GU, or 80 GU, as measured at an angle of 60 degrees in accordance with ASTM D523.

The molded article according to the present invention may have a color difference (ΔE) of about 2.0 or less, for example about 1.8 or less, and as another example, 0.1, 0.2, 0.3, 0.4, 0.5, 0.6, 0.7, 0.8, 0.9, 1.0, 1.1, 1.2, 1.3, 1.4, 1.5, 1.6, 1.7, or 1.8, as measured before and after UV exposure at 2,400 kJ/m² in accordance with FLTM B0116-1 (Ford Motor Co.).

Next, the present invention will be described in more detail with reference to the following examples. It should be understood that these examples are provided for illustration only and are not to be construed in any way as limiting the present invention.

Descriptions of details apparent to those skilled in the art will be omitted for clarity.

### EXAMPLES

Details of components used in the following Examples and Comparative Examples are as follows:

(A) Polycarbonate Resin

A bisphenol A-type linear polycarbonate resin having a weight average molecular weight of 25,000 g/mol

(B-1) First Vinyl-Modified Graft Copolymer

(b-1-1) A graft copolymer (average particle diameter (D50) of rubbery polymer: 8 μm) prepared by grafting 85 wt % of a vinyl monomer (weight ratio of styrene to acrylonitrile: 76:24) to 15 wt % of a rubbery polymer composed of polybutadiene having an average index of refraction of 1.51 by a typical bulk polymerization method

(b-1-2) A graft copolymer (average particle diameter (D50) of rubbery polymer: 260 nm) prepared by grafting 42 wt % of a vinyl monomer (weight ratio of styrene to acrylonitrile: 76:24) to 58 wt % of a rubbery polymer composed of polybutadiene having an average index of refraction of 1.51 by a typical emulsion polymerization method

(B-2) Second Vinyl-Modified Graft Copolymer

(b-2-1) A graft copolymer (average particle diameter (D50) of rubbery polymer: 200 nm) prepared by grafting 50 wt % of a vinyl monomer (weight ratio of styrene to acrylonitrile: 67:33) to 50 wt % of a rubbery polymer composed of poly(butyl acrylate) having an average index of refraction of 1.47 by a typical emulsion polymerization method

(b-2-2) A graft copolymer (Metablen SRK-200, MRC) prepared by grafting styrene and acrylonitrile to a rubbery polymer composed of poly(organosiloxane-butylacrylate) having an average index of refraction of 1.43

(b-2-3) A graft copolymer (Metablen S-2100, MRC) prepared by grafting methyl methacrylate to a rubbery polymer composed of poly(organosiloxane-butylacrylate) having an average index of refraction of 1.43

(C) Aromatic Vinyl Copolymer

A styrene-acrylonitrile copolymer resin (weight average molecular weight: 150,000 g/mol) prepared from a monomer mixture including 76 wt % of styrene and 24 wt % of acrylonitrile by a typical suspension polymerization method

(D) Metal Particles

Aluminum particles having an average particle diameter (D50) of 30 μm (Yamoto Metal Co., Ltd.)

(E) UV Stabilizer

Tinuvin 329 produced by BASF

### Examples 1 to 9 and Comparative Examples 1 to 7

The above components are mixed in amounts as listed in Table 1, followed by melt extrusion, thereby preparing a thermoplastic resin composition in pellet form. Here, a twin-screw extruder (L/D=29, φ=45 mm) is used, and a barrel temperature is set to 250° C. The pelletized polycarbonate resin composition is dried at 80° C. for 2 hours, followed by injection molding using a 6 oz. injection machine at a cylinder temperature of 250° C. and a mold temperature of 60° C., thereby preparing a specimen for property evaluation having a size of 90 mm×50 mm×2 mm (length×width×thickness).

In table 1, the amounts of (A), (B-1), (B-2), and (C) are represented in % by weight based on the total weight of the base resin, and the amounts of (D) and (E) are represented in parts by weight based on 100 parts by weight of the base resin.

TABLE 1

| | | Example | | | | | | | | | Comparative Example | | | | | | |
|---|---|---|---|---|---|---|---|---|---|---|---|---|---|---|---|---|---|
| Item | | 1 | 2 | 3 | 4 | 5 | 6 | 7 | 8 | 9 | 1 | 2 | 3 | 4 | 5 | 6 | 7 |
| (A) | | 65 | 65 | 65 | 65 | 65 | 50 | 75 | 65 | 65 | 65 | 65 | 65 | 65 | 65 | 50 | 75 |
| (B-1) | (b-1-1) | 30 | 20 | 15 | 15 | — | 20 | 15 | 15 | 15 | 35 | 25 | 20 | — | — | 25 | 20 |
| | (b-1-2) | — | — | 5 | — | 15 | 10 | 5 | 5 | 5 | — | — | 5 | 25 | — | 10 | 5 |
| (B-2) | (b-2-1) | 5 | 5 | 5 | 10 | 10 | 5 | 5 | — | — | — | — | — | — | 25 | — | — |
| | (b-2-2) | — | — | — | — | — | — | — | 5 | — | — | — | — | — | — | — | — |
| | (b-2-3) | — | — | — | — | — | — | — | — | 5 | — | — | — | — | — | — | — |

| | | | | | | | | | | | | | | | | |
|---|---|---|---|---|---|---|---|---|---|---|---|---|---|---|---|---|
| (C) | — | 10 | 10 | 10 | 10 | 15 | — | 10 | 10 | — | 10 | 10 | 10 | 10 | 15 | — |
| (D) | 1 | 1 | 1 | 1 | 1 | 1 | 1 | 1 | 1 | 1 | 1 | 1 | 1 | 1 | 1 | 1 |
| (E) | 1 | 1 | 1 | 1 | 1 | 1 | 1 | 1 | 1 | 1 | 1 | 1 | 1 | 1 | 1 | 1 |

Each of the prepared specimens is evaluated as to gloss, impact resistance, fluidity, light resistance, appearance, and chemical resistance according to the following methods. Results are shown in Table 2.

Property Evaluation

(1) Gloss (GU): Gloss is measured at 60° using a gloss meter (BYK-Gardner, BYK Chemie) in accordance with ASTM D523.

(2) Impact resistance (kgf·cm/cm): Izod impact strength is measured on a ⅛″ thick notched specimen in accordance with ASTM D256.

(3) Fluidity (g/10 min): Melt-flow index is measured at 220° C. under a load of 10 kg in accordance with ASTM D1238.

(4) Light resistance: Color difference (ΔE) is measured before and after UV exposure at 2,400 kJ/m² in accordance with FLTM B0116-1 (Ford Motor Co.).

(5) Appearance: For each specimen, occurrence of a flow-mark and distribution and orientation of metal particles are observed with the naked eye. Each criterion is scored on a scale of 1 to 5 (1: bad, 5: good).

(6) Chemical resistance: With each of the specimens placed on a ¼ ellipse jig, a thinner is applied to a surface of the specimen and left for 2 hours. Then, occurrence of cracks is observed to evaluate chemical resistance. A specimen without cracks is rated as OK, and a specimen having cracks was rated as NG.

TABLE 2

| | Example | | | | | | | | | Comparative Example | | | | | | |
|---|---|---|---|---|---|---|---|---|---|---|---|---|---|---|---|---|
| Item | 1 | 2 | 3 | 4 | 5 | 6 | 7 | 8 | 9 | 1 | 2 | 3 | 4 | 5 | 6 | 7 |
| Gloss (GU) | 50 | 59 | 63 | 61 | 82 | 68 | 72 | 62 | 64 | 49 | 57 | 62 | 89 | 87 | 58 | 61 |
| Impact | 43 | 45 | 48 | 50 | 57 | 62 | 54 | 50 | 51 | 39 | 37 | 45 | 60 | 55 | 59 | 50 |
| resistance | | | | | | | | | | | | | | | | |
| (kgf · cm/cm) | | | | | | | | | | | | | | | | |
| Fluidity (g/10 | 36 | 41 | 39 | 39 | 37 | 37 | 27 | 35 | 37 | 37 | 44 | 41 | 40 | 31 | 38 | 29 |
| min) | | | | | | | | | | | | | | | | |
| Light resistance | 1.0 | 0.8 | 1.1 | 0.6 | 1.8 | 1.7 | 1.1 | 1.3 | 1.0 | 1.4 | 1.1 | 1.5 | 3.1 | 0.4 | 2.6 | 1.4 |
| (ΔE) | | | | | | | | | | | | | | | | |
| Appearance | 5 | 5 | 5 | 5 | 4 | 4 | 5 | 4.5 | 4 | 5 | 5 | 4 | 1 | 2 | 3 | 4 |
| Chemical | OK | OK | OK | OK | OK | OK | OK | OK | OK | NG | NG | NG | NG | OK | NG | NG |
| resistance | | | | | | | | | | | | | | | | |

As shown in Table 2, it can be seen that the specimens of Examples 1 to 9 including two vinyl-modified graft copolymers including rubbery polymers having different average indexes of refraction have low gloss and excellent properties in terms of impact resistance, chemical resistance, light resistance, and appearance. Conversely, the specimens of Comparative Examples 1 to 4, 6, and 7 using the first vinyl-modified graft copolymer alone have poor properties in terms of chemical resistance, appearance, and/or light resistance, and the specimen of Comparative Example 5 using the second vinyl-modified graft copolymer alone has high gloss and poor appearance.

Exemplary embodiments have been disclosed herein, and although specific terms are employed, they are to be interpreted in a generic and descriptive sense only and not for purpose of limitation. Also although some embodiments have been described above, it should be understood that these embodiments are provided for illustration only and are not to be construed in any way as limiting the present invention, and that various modifications, changes, and alterations can be made by those skilled in the art without departing from the spirit and scope of the invention. The scope of the present invention should be defined by the appended claims and equivalents thereof.

What is claimed is:

1. A thermoplastic resin composition, comprising:
a base resin comprising a polycarbonate resin, a first vinyl-modified graft copolymer, and a second vinyl-modified graft copolymer, wherein the first and second vinyl-modified graft copolymers comprise rubbery polymers having different average indexes of refraction, respectively; and
metal particles,
wherein a difference between the average indexes of refractions of the rubbery polymers is greater than or equal to about 0.02.

2. The thermoplastic resin composition according to claim 1, wherein the rubbery polymer of the first vinyl-modified graft copolymer has an average index of refraction of greater than about 1.49 to about 1.53.

3. The thermoplastic resin composition according to claim 1, wherein the rubbery polymer of the second vinyl-modified graft copolymer has an average index of refraction of about 1.39 to about 1.49.

4. The thermoplastic resin composition according to claim 1, wherein the first vinyl-modified graft copolymer comprises a diene-based rubbery polymer.

5. The thermoplastic resin composition according to claim 1, wherein the second vinyl-modified graft copolymer comprises an acrylic rubbery polymer.

6. The thermoplastic resin composition according to claim 1, wherein the base resin comprises about 40 wt % to about 90 wt % of the polycarbonate resin, about 5 wt % to about 50 wt % of the first vinyl-modified graft copolymer, and about 1 wt % to about 50 wt % of the second vinyl-modified graft copolymer.

7. The thermoplastic resin composition according to claim 1, wherein the metal particles have an average particle diameter (D50) of about 5 μm to about 100 μm.

8. The thermoplastic resin composition according to claim 1, wherein the metal particles are present in an amount of about 0.1 parts by weight to about 10 parts by weight based on about 100 parts by weight of the base resin.

9. The thermoplastic resin composition according to claim 1, wherein the base resin further comprises an aromatic vinyl copolymer.

10. The thermoplastic resin composition according to claim 9, wherein the aromatic vinyl copolymer is present in an amount of about 30 wt % or less in the base resin.

11. The thermoplastic resin composition according to claim 1, further comprising a UV stabilizer.

12. The thermoplastic resin composition according to claim 11, wherein the UV stabilizer is present in an amount of about 4 parts by weight or less based on about 100 parts by weight of the base resin.

13. A molded article formed of the thermoplastic resin composition according to claim 1.

14. The molded article according to claim 13, wherein the molded article has a gloss of about 85 GU or less, as measured at an angle of 60 degrees in accordance with ASTM D523.

15. The molded article according to claim 13, wherein the molded article has a color difference (ΔE) of about 2.0 or less, as measured before and after UV exposure at 2,400 kJ/m² in accordance with FLTM B0116-1.
